(19) United States
(12) Patent Application Publication
(10) Pub. No.: US 2026/0194269 A1
(43) Pub. Date: Jul. 9, 2026

(54) METHODS AND SYSTEMS FOR CONTROLLING A COMPRESSOR COOLING SYSTEM

(71) Applicant: Copeland LP, Sidney, OH (US)

(72) Inventors: Matthew J. Swallow, Versailles, OH (US); Brian McHugh, Troy, OH (US); Michael M. Perevozchikov, Tipp City, OH (US)

(21) Appl. No.: 19/010,907

(22) Filed: Jan. 6, 2025

(51) Int. Cl. F25B 31/00

(52) U.S. Cl. CPC F25B 31/006

(57) ABSTRACT

A method includes storing a time T_{ON}, a time T_{OFF}, and an override flag; and executing a duty cycle logic loop. The duty cycle logic loop includes receiving temperature readings from the one or more temperature sensors for the one or more locations; if a determination is that any of the temperature readings are above an upper temperature threshold, incrementing the time T_{ON}, setting the override flag to true, and opening the cooling valve; if a determination is that time T_{OFF} is complete, opening the cooling valve, starting time T_{ON}, and if a determination is that all temperature readings are lower than the lower temperature threshold or any temperature is lower than the superheat margin, decrementing time T_{ON}.

### FIELD

The field relates generally to cooling systems for compressors, and more particularly, to methods and systems for controlling a compressor cooling system.

### BACKGROUND

Some compressors include cooling systems to provide cooling to the motor and bearings associated with the compressor driveshaft to maintain the motor and bearings within a suitable range of operating temperatures. In at least some systems, one or more cooling paths, such as a cooling path to provide coolant to the motor, can be selectively used through control of a coolant valve by a controller.

In current systems, undesired significant temperature swings may occur during the cooling cycle. There is also a risk of “thermal runaway,” for example, if temperatures are allowed to rise for too long or too quickly prior to cooling being applied. For example, overcooling can lead to large temperature differences within parts of the compressor.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a compressor system includes a compressor, a cooling circuit, and a controller. The compressor includes a compressor housing defining one or more refrigerant inlets, a cooling circuit comprising: one or more coolant supply lines connected to the compressor housing to deliver coolant to the one or more refrigerant inlets; and a cooling valve configured to control a flow of coolant via the one or more coolant supply lines; one or more temperature sensors to measure temperature at one or more locations in the compressor; and a controller having a processor and a memory. The controller is connected to the one or more temperature sensors and the cooling valve. The memory storing instructions that when executed by the processor configures the controller to: a) control the compressor to compress refrigerant delivered to the one or more refrigerant inlets; b) store a time T_{ON}, a time T_{OFF}, and an override flag; and c) execute a duty cycle logic loop comprising: i) receive compressor temperature readings from the one or more temperature sensors for the one or more locations; ii) if a determination is made that any of the compressor temperature readings are above an upper temperature threshold, increment the time T_{ON}, set the override flag to true, and open the cooling valve; iii) if a determination is that the override flag is set to true and all of the compressor temperature readings are below the upper temperature threshold, close the cooling valve, set the override flag to false, and begin time T_{OFF}; iv) if a determination is that time T_{OFF} is complete, open the cooling valve, start time T_{ON}, and determine if all compressor temperature readings are lower than a lower temperature threshold; v) if the determination is that all compressor temperature readings are lower than the lower temperature threshold, decrement time T_{ON}; and vi) if a determination is that time T_{ON} is complete, close the cooling valve and begin time T_{OFF}. The compressor system may have additional, less, or alternate functionalities, including those discussed elsewhere herein.

In another aspect, a controller includes at least one processor and at least one memory. The controller is connected to one or more temperature sensors to measure one or more locations on a device and a cooling valve for controlling a flow of coolant to the one or more locations on the device. The at least one memory storing instructions that when executed by the at least one processor configures the controller to: a) store a time T_{ON}, a time T_{OFF}, and an override flag; and b) execute a duty cycle logic loop comprising: i) receive temperature readings from the one or more temperature sensors for the one or more locations; ii) if a determination is that any of the temperature readings are above an upper temperature threshold, increment the time T_{ON}, set the override flag to true, and open the cooling valve; iii) if a determination is that the override flag is set to true and all of the temperature readings are below the upper temperature threshold, close the cooling valve, set the override flag to false, and begin time T_{OFF}; iv) if a determination is that time T_{OFF} is complete, open the cooling valve, start time T_{ON}, and determine if all temperatures readings are lower than a lower temperature threshold; v) if the determination is that all temperature readings are lower than the lower temperature threshold, decrement time T_{ON}; and vi) if a determination is that time T_{ON} is complete, close the cooling valve and begin time T_{OFF}. The controller may have additional, less, or alternate functionalities, including those discussed elsewhere herein.

In yet another aspect, a method for controlling a compressor is implemented by a controller including at least one processor and at least one memory. The controller in communication with one or more temperature sensors to measure one or more locations on the compressor and a cooling valve for controlling a flow of coolant to the one or more locations on the compressor. The method includes: a) storing a time T_{ON}, a time T_{OFF}, and an override flag; and b) executing a duty cycle logic loop including: i) receiving temperature readings from the one or more temperature sensors for the one or more locations; ii) if a determination is that any of the temperature readings are above an upper temperature threshold, incrementing the time T_{ON}, setting the override flag to true, and opening the cooling valve; iii) if a determination is that the override flag is set to true and all of the temperature readings are below the upper temperature threshold, closing the cooling valve, setting the override flag to false, and beginning time T_{OFF}; iv) if a determination is that time T_{OFF} is complete, opening the cooling valve, starting time T_{ON}, and determining if all temperatures readings are lower than a lower temperature threshold; v) if the determination is that all temperature readings are lower than the lower temperature threshold, decrementing time T_{ON}; and vi) if a determination is that time T_{ON} is complete, closing the cooling valve and beginning time T_{OFF}.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements presently discussed, it being understood, however, that the present embodiments are not limited to the precise arrangements.

FIG. 1 illustrates a schematic diagram of an example refrigeration system.

FIG. 2 illustrates a schematic diagram of an example compressor cooling system suitable for use in the refrigeration system of FIG. 1.

FIG. 3 illustrates a sectional view of a portion of the compressor cooling system shown in FIG. 2, showing a temperature sensor connected to a coolant return line.

FIG. 4 is a graph illustrating operation of a previous cooling system.

FIG. 5 is a graph illustrating operation of the compressor cooling system shown in FIG. 2 using the control process described in FIG. 6.

FIG. 6 illustrates a flowchart of a process for controlling the operations of the compressor cooling system shown in FIG. 2.

FIG. 7 illustrates an example configuration of a client computer device, in accordance with one embodiment of the present disclosure.

Corresponding reference characters indicate corresponding parts throughout the drawings.

### DETAILED DESCRIPTION

The present embodiments may relate to, inter alia, systems and methods for controlling a compressor cooling system. More specifically, the systems and methods described herein provide a system for dynamically adjusting duty cycle cooling to improve performance for a system with solenoid valve style (on/off) cooling. A controller adjusts the duty cycle cooling timing so that a cooling valve is opened prior to temperatures reaching their upper thresholds and closed prior to temperatures reaching their lower thresholds. There is also a back-up override to prevent high temperatures. Advantages include, but are not limited to, reducing the amplitude of temperature swings to improve the reliability of compressor components, reducing the risk of liquid introduction due to long cooling cycles, and more consistent cooling valve movements to improve chiller system consistency.

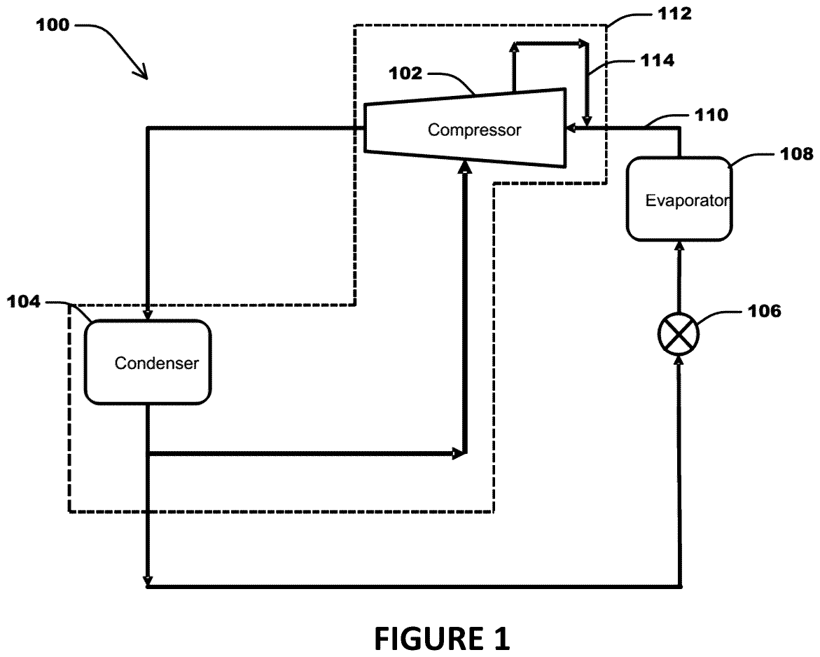

FIG. 1 is a schematic diagram of an example refrigeration system 100. The refrigeration system 100 includes a compressor 102, a condenser 104, an expansion device 106 (e.g., an expansion valve, orifice, capillary tube), and an evaporator 108. The refrigeration system 100 may include additional components or other components than those shown and described with reference to FIG. 1 without departing from the scope of the present disclosure. In operation, the compressor 102 receives a working fluid, such as a refrigerant, as a low pressure gas through a suction line 110. The compressor 102 compresses the gas, thereby raising the temperature and pressure of the gas. The pressurized, high temperature gas then flows to the condenser 104, where the high pressure gas is condensed to a high pressure liquid. The liquid then flows through an expansion device 106 that reduces the pressure of the liquid. The reduced pressure fluid, which may be a gas or a mixture of gas and liquid after passing through the expansion device 106, then passes through the evaporator 108. The evaporator 108 may include a heat exchanger, with a fluid circulating therethrough that is cooled by the reduced pressure refrigerant fluid as the refrigerant fluid evaporates to a gas in the evaporator 108. The refrigerant gas is then directed back to the compressor 102 via the suction line 110, where the working fluid is again compressed and the process repeats.

The example refrigeration system 100 includes a compressor cooling system 112 that draws working fluid from part of the refrigerant circuit (downstream of the condenser 104 in this example) and directs it to the compressor 102 to cool components of the compressor 102, such as a motor and bearings of the compressor 102. The working fluid used in the cooling system 112, referred to as “coolant”, is returned to the refrigeration circuit by a coolant return line 114 that has an outlet connected to a low pressure side of the compressor 102 (e.g., the suction line 110). As described further herein, the pressure differential across the cooling circuit of the cooling system 112 drives coolant through the compressor 102, and back into the refrigeration circuit.

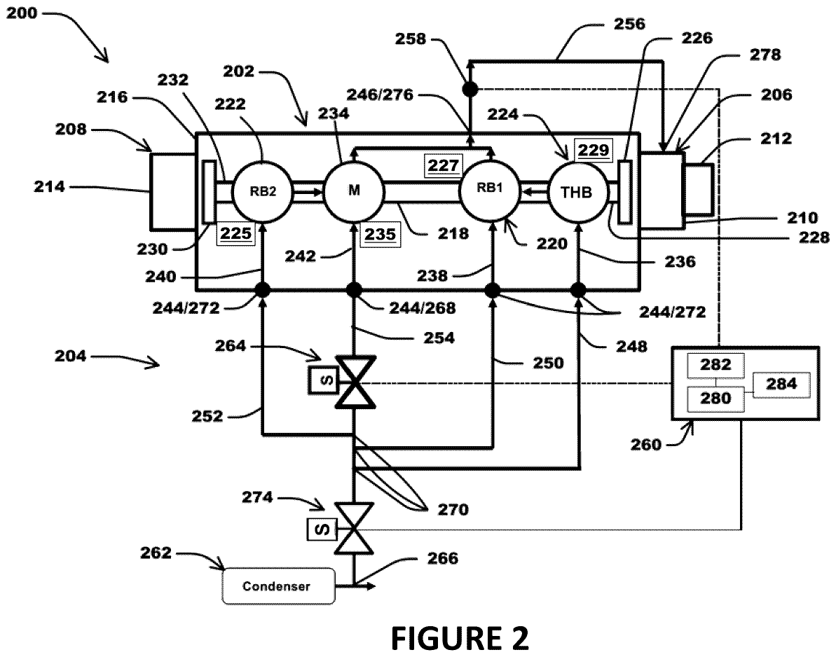

FIG. 2 is a schematic diagram of an example compressor cooling system 200 suitable for use in the refrigeration system 100 of FIG. 1. The compressor cooling system 200 includes a compressor 202 (e.g., compressor 102) and a cooling circuit 204 configured to deliver coolant to components of the compressor 202 to facilitate cooling the compressor 202 and maintaining components of the compressor 202 within suitable operating temperature ranges.

The compressor 202 of the illustrated embodiment is a two-stage centrifugal compressor 202 that includes a first stage 206 and a second stage 208. In other embodiments, the compressor 202 may include a single stage or may include more than two stages. In yet other embodiments, the compressor 202 may be a compressor other than a centrifugal compressor, such as a scroll compressor. The first stage 206 includes a first stage inlet 210 that is connected in fluid communication with an evaporator (e.g., evaporator 108, shown in FIG. 1) by a suction line 212. The second stage 208 includes a second stage inlet 214 that is connected in fluid communication with a first stage outlet of the first stage 206 by a refrigerant transfer conduit (not shown in FIG. 2) to receive compressed refrigerant from the first stage 206.

The compressor 202 generally includes a housing 216, a shaft 218 rotatably supported in the housing 216 by a plurality of bearings 220, 222, 224, a first stage impeller 226 connected to a first end 228 of the shaft 218, a second stage impeller 230 connected to a second end 232 of the shaft 218, and a motor 234 operably connected to the shaft 218 to drive rotation thereof. The compressor 202 may include components in addition to those shown in FIG. 2.

The housing 216 encloses components of the compressor 202 within one or more sealed (e.g., hermetically or semi-hermitically) cavities. In some embodiments, for example, the housing 216 includes end caps at each stage of the compressor 202 that define volutes in which the first and second stage impellers 226, 230 are positioned. In some embodiments, the housing 216 is formed from a plurality of cast pieces that are assembled using suitable fasteners (e.g., screws, bolts, etc.)

The bearings 220, 222, 224 rotatably support the shaft 218 within the housing 216. In the illustrated embodiment, the compressor 202 includes a first radial bearing 220, a second radial bearing 222, and a thrust bearing 224. In other embodiments, the compressor 202 may include additional or fewer bearings. The bearings 220, 222, 224 may include any suitable type of bearings that enable the compressor 202 to function as described herein including, for example and without limitation, roller-type bearings, magnetic bearings, fluid film bearings, air foil bearings, and combinations thereof. In the illustrated embodiment, each of the bearings 220, 222, 224 comprises an air foil type bearing. In the example embodiment, bearing temperature sensors 225, 227, and 229 are positioned proximate each of the bearings 220, 222, and 224 to provide measurements of the first radial bearing temperature (TRB1), the second radial bearing temperature (TRB2), and the thrust bearing temperature (TTHB) to the controller 260. The bearing temperature sensors 225, 227, and 229 may be any suitable temperature sensor and may each measure the temperature of its associated bearing directly (e.g., by measuring the actual temperature of the bearing, such as by contact with the bearing) or indirectly (e.g., by measuring a temperature corresponding to or affected by the actual temperature of the bearing).

The motor 234 is operably connected to the shaft 218 to drive rotation thereof during operation of the compressor 202. The motor 234 may generally include any suitable motor that enables the compressor 202 to function as described herein. In the illustrated embodiment, the motor 234 is an electric motor and includes suitable components (e.g., a stator and a rotor) to impart rotational motion to the shaft 218 during operation of the compressor 202. A motor temperature sensor 235 is positioned to provide measurements of the motor temperature (TM) to the controller 260. Although only one motor temperature sensor 235 is shown in FIG. 2, multiple motor temperature sensors 235 may be used to monitor the temperature of more than one components or locations on the motor 234. The motor temperature sensor(s) 235 may be any suitable temperature sensor and may each measure the temperature directly (e.g., by measuring the actual temperature of a component of the motor, such as by contact with the component) or indirectly (e.g., by measuring a temperature corresponding to or affected by the actual temperature of the motor or a component of the motor).

The housing 216 has a plurality of coolant flow channels 236, 238, 240, 242 defined therein that delivers coolant to the bearings 220, 222, 224 and the motor 234. The coolant flow channels 236, 238, 240, 242 may be arranged and/or defined within the compressor housing 216 in any manner that enables the compressor cooling system 200 to function as described herein. For example, the coolant flow channels 236, 238, 240, 242 may be formed as passages in components (e.g., defined in cast components, machined into components, or the like) of the compressor housing 216, as passages defined between two or more components of the compressor 202 (e.g., between the motor 234 and the compressor housing 216), and combinations thereof. Alternatively or additionally, one or more of the coolant flow channels 236, 238, 240, 242 may be separate channels (i.e., separate from and not formed in the housing) positioned in the housing 216. In some embodiments one or more portion of one or more of the coolant flow channels 236, 238, 240, 242 may be external to the housing 216.

The example compressor 202 includes a first coolant flow channel 236, a second coolant flow channel 238, a third coolant flow channel 240, and a fourth coolant flow channel 242. The first coolant flow channel 236 delivers coolant to the thrust bearing 224, the second coolant flow channel 238 delivers coolant to the first radial bearing 220, the third coolant flow channel 240 delivers coolant to the second radial bearing 222, and the fourth coolant flow channel 242 delivers coolant to the motor 234. The fourth coolant flow channel is sometimes referred to as the motor coolant flow channel 242. In some embodiments, the coolant flow channels 236, 238, 240, 242 may share common or overlapping portions. In the illustrated embodiment, for example, the first coolant flow channel 236 overlaps with and feeds into the second coolant flow channel 238 at the first radial bearing 220, and the third coolant flow channel 240 overlaps with and feeds into the fourth coolant flow channel 242 at the motor 234.

Each of coolant flow channels 236, 238, 240, 242 has a corresponding coolant inlet port 244 that connects to the cooling circuit 204 in the example embodiment. That is, the compressor housing 216 includes four external inlet connections for connecting the plurality of coolant flow channels 236, 238, 240, 242 to the cooling circuit 204. In other embodiments, the compressor housing 216 may have fewer external inlet connections. For example, two or more of the coolant flow channels 236, 238, 240, 242 may share a common, single coolant inlet port (and a common connection point to the cooling circuit 204) that provides coolant to multiple of the coolant flow channels 236, 238, 240, 242. In such embodiments, coolant flow delivered to the common coolant inlet port may be separated, divided, or otherwise routed within the compressor housing 216 to deliver coolant to two or more of the coolant flow channels 236, 238, 240, 242. In some embodiments, for example, the bearing coolant flow channels (i.e., the first, second, and third coolant flow channels 236, 238, 240) may have a common coolant inlet port, and the coolant flow may be routed to the separate flow channels internally within the compressor housing 216.

The compressor housing 216 also defines a common coolant outlet port 246 in the illustrated embodiment. The common coolant outlet port 246 receives coolant from each of the plurality of coolant flow channels 236, 238, 240, 242. In other words, all of the coolant delivered to the compressor housing 216 and the coolant flow channels 236, 238, 240, 242 is returned to the common coolant outlet port 246. In some embodiments, at least one of the plurality of coolant flow channels 236, 238, 240 is arranged such that coolant flows through at least one coolant flow channel, in series, across at least one of the bearings 220, 222, 224, through the motor 234, and to the common coolant outlet port 246. In this way, coolant flowing through the at least one coolant flow channel absorbs heat from both the motor 234 and one of the bearings 220, 222, 224. Coolant may flow through the motor 234, for example, by flowing between a stator and a rotor of the motor 234, through a portion of the shaft 218 around which the motor 234 is disposed, and/or through flow channels or holes defined in the rotor of the motor 234.

The cooling circuit 204 delivers coolant to the compressor housing 216 (specifically, to the plurality of coolant flow channels 236, 238, 240, 242) and returns coolant to the refrigeration circuit (e.g., refrigeration system 100 shown in FIG. 1) of which the compressor 202 is a part. The illustrated cooling circuit 204 includes a plurality of coolant supply lines 248, 250, 252, 254, a coolant return line 256, a temperature sensor 258, and a controller 260.

The coolant supply lines 248, 250, 252, 254 are connected in fluid communication with a coolant source 262 and are connected to the compressor housing 216 to deliver coolant to the plurality of coolant flow channels 236, 238, 240, 242. The coolant supply lines 248, 250, 252, 254 can include any suitable fluid conduit (rigid and/or flexible) that enables delivery of coolant to the compressor housing 216 including, for example and without limitation, pipes, hoses, tubes, and combinations thereof. In some embodiments, the coolant supply lines 248, 250, 252, 254 are constructed of metal tubing, such as copper tubing. The illustrated cooling circuit 204 includes four coolant supply lines 248, 250, 252, 254, one for each of the coolant flow channels 236, 238, 240, 242 defined within the compressor housing 216. More specifically, the illustrated embodiment includes a plurality of bearing coolant supply lines 248, 250, 252 and a motor coolant supply line 254. Each of the bearing coolant supply lines 248, 250, 252 is connected to one of the first, second, and third coolant flow channels 236, 238, 240 to channel or deliver coolant to at least one of compressor bearings 220, 222, 224. The motor coolant supply line 254 is connected to the fourth coolant flow channel 242 to deliver coolant to the motor 234.

The example coolant source 262 is the refrigeration circuit of which the compressor 202 is a part, specifically, coolant drawn from the refrigeration circuit downstream of a condenser (e.g., condenser 104, shown in FIG. 1) of the refrigeration circuit, such as between the condenser and an expansion device of the refrigeration system. The coolant is the same working fluid (e.g., refrigerant) used in the refrigerant system in the example. In other embodiments, the coolant source 262 may be a portion of the refrigeration system other than downstream of the condenser, such as the condenser, or any other suitable coolant source that enables the compressor cooling system 200 to function as described herein. In yet other embodiments, the coolant source 262 may be an auxiliary liquid cycle.

As explained further herein, coolant is drawn from the coolant source 262 and through the cooling circuit 204 using a pressure differential between the coolant source 262 and an outlet end of the return line 256. In other embodiments, coolant may be directed through the cooling circuit 204 using additional or alternative means, such as a pump.

The motor coolant supply line 254 includes a motor coolant control valve 264 (sometimes referred to simply as the control valve 264) to control coolant flow through the motor coolant supply line 254. The control valve 264 includes an electrically-actuatable valve that is controllable by the controller 260 to vary or otherwise control the flow rate of coolant through the corresponding supply line. Suitable valves include, for example and without limitation, solenoid valves, electronic expansion valves, and modulating control valves. In other embodiments, one or more of the bearing coolant supply lines 248, 250, 252 may include a coolant control valve 264. In yet other embodiments, the motor coolant supply line 254 and one or more of the bearing coolant supply lines 248, 250, 252 may include a coolant control valve 264.

The motor coolant supply line 254 is configured as a primary or main coolant supply line in the illustrated embodiment, having an inlet 266 connected to the coolant source 262 and an outlet 268 connected to the compressor housing 216 to deliver coolant to the fourth coolant flow channel 242. The bearing coolant supply lines 248, 250, 252 are configured as branch lines in the illustrated embodiment, each having an inlet 270 connected to the motor coolant supply line 254 upstream of the motor coolant control valve 264, and an outlet 272 connected to the compressor housing 216 to deliver the coolant to the first, second, and third coolant flow channels 236, 238, 240. In other embodiments, the inlet 270 of one or more of the bearing coolant supply lines 248, 250, 252 may be connected to the coolant source 262. In yet other embodiments, the motor coolant supply line 254 may be configured as a branch circuit extending off of one of the bearing coolant supply lines 248, 250, 252.

The illustrated cooling circuit 204 also includes a shutoff valve 274 on the main coolant supply line (i.e., the motor coolant supply line 254) to enable coolant flow to the entire cooling circuit to be shut off in order to isolate the compressor from the rest of the system, (e.g., for service). The shutoff valve 274 may be omitted in other embodiments.

In the illustrated embodiment, the bearing coolant supply lines 248, 250, 252 are free of shutoff valves or other devices that would cut the supply of coolant through the bearing coolant supply lines 248, 250, 252. Thus, while the cooling circuit 204 is active (i.e., the shutoff valve 274 is open), the bearing coolant supply lines 248, 250, 252 are configured to continuously supply coolant to the compressor housing 216, irrespective of a position of the motor coolant control valve 264. In this way, the bearings of the compressor 202 are continuously supplied with coolant during operation to facilitate maintaining bearings within a suitable range of operating temperatures. The bearing coolant flow paths—including the bearing coolant supply lines 248, 250, 252 and the associated coolant flow channels 236, 238, 240 defined within the compressor housing 216—can include flow restrictors along the flow path to restrict or otherwise limit the flow of coolant therethrough. The flow restrictors may be included in the bearing coolant supply lines 248, 250, 252 and/or may be integrated into the compressor housing 216 (e.g., as metering orifices along the coolant flow channels). In some embodiments, for example, one or more of the coolant inlet ports 244 associated with the bearing coolant flow channels 236, 238, 240 includes a metering orifice to control the flow of coolant therethrough.

The coolant return line 256 is connected to the compressor housing 216 to receive coolant from the coolant flow channels 236, 238, 240, 242 and return coolant to a low-pressure side of the compressor 202. The low pressure side of the compressor 202 generally refers to portions of the compressor 202 and the refrigeration circuit of which the compressor 202 is a part that precede the compression stages of the compressor 202 (i.e., the first stage 206 and the second stage 208). The low pressure side of the compressor 202 may include, for example and without limitation, a portion of the compressor 202 upstream of the first stage impeller 226, an inlet to the first stage 206, and the suction line 212 connected to the inlet of the first stage 206.

The coolant return line 256 can include any suitable fluid conduit (rigid and/or flexible) that enables delivery of coolant from the compressor housing 216 to the lower pressure side of the compressor 202. Suitable conduits include, for example and without limitation, pipes, hoses, tubes, and combinations thereof. In some embodiments, the coolant return line 256 is constructed of metal tubing, such as copper tubing. In other embodiments, the coolant return line 256 is constructed of other materials. In some embodiments, the coolant return line is formed as part of the housing 216. Additionally, in some embodiments, the return line 256 may include a flat portion or section to facilitate mounting the temperature sensor 258.

An inlet 276 of the coolant return line 256 is connected to the common coolant outlet port 246, and an outlet 278 of the coolant return line 256 is connected to the low-pressure side of the compressor 202. Coolant at the coolant source 262 (e.g., the condenser 104) is generally at a higher pressure than the low pressure side of the compressor 202. As a result, a pressure differential exists between coolant at the coolant source 262 and the low pressure side of the compressor 202, which facilitates driving coolant through the cooling circuit 204.

The coolant return line 256 is connected to the common coolant outlet port 246 and receives coolant from each of the coolant flow channels 236, 238, 240, 242 after the coolant absorbs heat from the motor 234 and/or the bearings 220, 222, 224. As noted above, at least one of the coolant flow channels 236, 238, 240, 242 can be arranged such that coolant flows through the at least one coolant flow channel, in series, across at least one of the bearings 220, 222, 224, through the motor 234, and to the common coolant outlet port 246. In the illustrated embodiment, for example, the third cooling flow channel 240 is arranged so the coolant flows, in series, across the second radial bearing 222, through the motor 234, and to the common coolant outlet port 246. As a result, coolant that flows through the coolant return line 256 has absorbed heat from at least one of the bearings 220, 222, 224 and the motor 234, even when the motor coolant control valve 264 is in an off position.

The temperature sensor 258 is connected to the coolant return line 256 to detect at least one of a temperature of the coolant return line 256 and a temperature of coolant within the coolant return line 256. The temperature sensor 258 can include any suitable temperature sensor that enables the cooling circuit 204 to function as described herein, including, for example and without limitation, thermistors, thermocouples, resistance temperature detectors (RTDs), thermal switches, and combinations thereof. In some embodiments, the temperature sensor 258 includes a negative temperature coefficient thermistor.

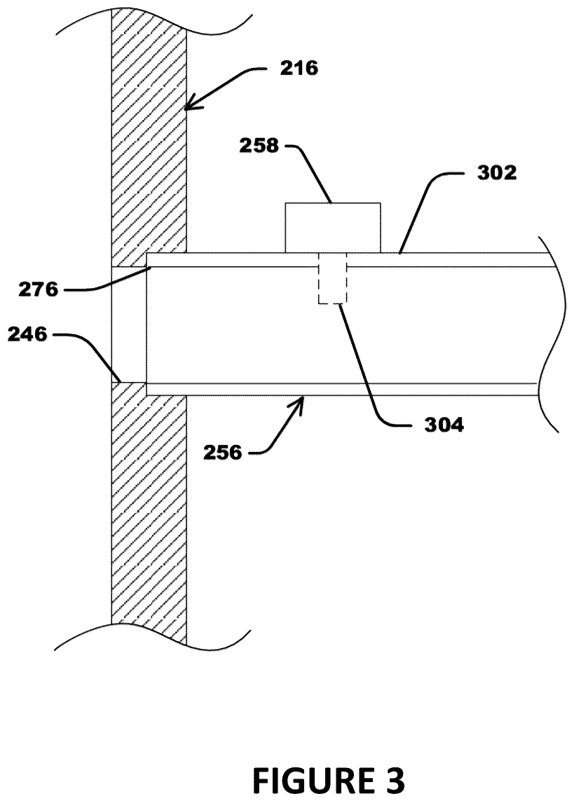

The temperature sensor 258 of this embodiment is located completely external of the compressor housing 216 and the coolant return line 256 and is configured to detect a temperature of the coolant return line 256. In other embodiments, the temperature sensor 258 and the coolant return line 256 are internal to or part of the compressor housing 216. As illustrated in FIG. 3, for example, the temperature sensor 258 is connected to an external surface 302 of the coolant return line 256 and is configured to detect a temperature of the external surface 302. In other embodiments, the temperature sensor 258 may include a probe 304 (shown in dashed lines in FIG. 3) that extends within the coolant return line 256 to detect a temperature of coolant flowing through the coolant return line 256.

The controller 260 is connected to the temperature sensor 258 and the motor coolant control valve 264 and is configured to control operation of the motor coolant control valve 264 (e.g., by opening, closing, or varying a position of the motor coolant control valve 264). In some embodiments, for example, the controller 260 is configured to control the motor coolant control valve 264 based on the temperature detected by the temperature sensor 258 to control the supply of coolant to the compressor housing 216. For example, the controller 260 may receive a signal from the temperature sensor 258 indicative of a temperature detected by the temperature sensor 258, compare the detected temperature to one or more temperature set points, and control the motor coolant control valve 264 based on the detected temperature. Furthermore, controller 260 may also be in communication with shutoff valve 274 that allows controller 260 to control whether shutoff valve 274 is open or closed to similarly control coolant flow to all coolant supply lines 248, 250, 252, 254.

The controller 260 generally includes any suitable computer and/or other processing unit, including any suitable combination of computers, processing units and/or the like that may be communicatively connected to one another and that may be operated independently or in connection within one another (e.g., controller 260 may form all or part of a controller network). Controller 260 may include one or more modules or devices, one or more of which is enclosed within the compressor 202, or may be located remote from the compressor 202. The controller 260 includes a processor 280, a memory device 282, and a communication interface 284 configured to perform a variety of computer-implemented functions (e.g., performing the calculations, determinations, and functions disclosed herein).

Although a single processor 280, memory device 282, and communication interface 284 are illustrated, the controller may include more than one of each component and may include additional components.

As used herein, the term “processor” refers not only to integrated circuits, but also refers to a controller, a microcontroller, a microcomputer, a programmable logic controller (PLC), an application specific integrated circuit, and other programmable circuits. Additionally, memory device(s) 282 of controller 260 may generally be or include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 282 may generally be configured to store suitable computer-readable instructions that, when implemented by the processor(s), configure or cause controller 260 to perform various functions described herein including, but not limited to, controlling the motor coolant control valve 264 and/or various other suitable computer-implemented functions.

The communication interface 284 enables the controller 260 to communicate with remote devices and systems, such as sensors, valve control systems, safety systems, remote computing devices, other components of the system, and the like. The communication interface 284 may be a wired or wireless communications interface that permits the controller to communicate with the remote devices and systems directly or via a network. Wireless communication interfaces may include a radio frequency (RF) transceiver, a Bluetooth® adapter, a Wi-Fi transceiver, a ZigBee® transceiver, an infrared (IR) transceiver, a near field communication (NFC) transceiver, and/or any other device and communication protocol for wireless communication. (Bluetooth is a registered trademark of Bluetooth Special Interest Group of Kirkland, Washington; ZigBee is a registered trademark of the ZigBee Alliance of San Ramon, California.) Wired communication interfaces may use any suitable wired communication protocol for direct communication including, without limitation, USB, RS485, RS232, I2C, SPI, analog, and proprietary I/O protocols. In some embodiments, the wired communication interface 284 may include a wired network adapter allowing the computing device to be coupled to a network, such as the Internet, a local area network (LAN), a wide area network (WAN), a mesh network, and/or any other network to communicate with remote devices and systems via the network.

The controller 260 and/or components of controller 260 may be integrated or incorporated within other components of the cooling circuit 204 and/or a refrigeration system within which the cooling circuit 204 is incorporated. For example, the controller 260 may be incorporated within the shutoff valve 274 and/or a system controller that controls other functions and operations of the compressor 202 and the refrigeration system.

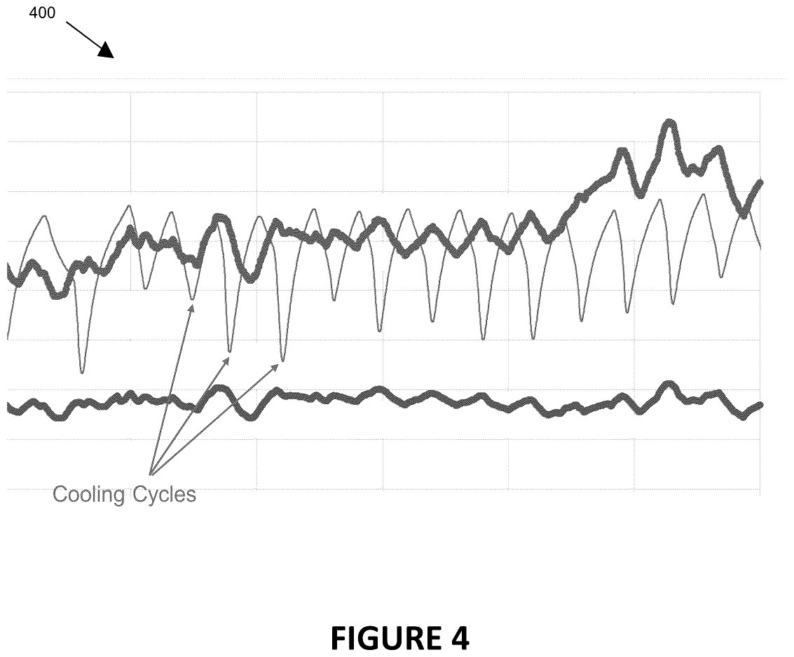

FIG. 4 is a graph 400 illustrating operation of a previous cooling system. Graph 400 illustrates the amount of time that the cooling valve is open during a given period.

In graph 400, line 405 illustrates compressor temperature, such as from one or more temperature sensors 225, 227, 229, 235, or 258 (shown in FIG. 2). In the illustrated embodiment, the compressor 202 includes a first radial bearing 220, a second radial bearing 222, and a thrust bearing 224 (all shown in FIG. 2). In other embodiments, the compressor 202 may include additional or fewer bearings. In the example embodiment, bearing temperature sensors 225, 227, and 229 (all shown in FIG. 2) are positioned proximate each of the bearings 220, 222, and 224 to provide measurements of the first radial bearing temperature (TRB1), the second radial bearing temperature (TRB2), and the thrust bearing temperature (TTHB) to the controller 260 (shown in FIG. 2). The bearing temperature sensors 225, 227, and 229 may be any suitable temperature sensor and may each measure the temperature of its associated bearing directly (e.g., by measuring the actual temperature of the bearing, such as by contact with the bearing) or indirectly (e.g., by measuring a temperature corresponding to or affected by the actual temperature of the bearing). In the illustrated embodiment, the motor 234 is an electric motor and includes suitable components (e.g., a stator and a rotor) to impart rotational motion to the shaft 218 (both shown in FIG. 2) during operation of the compressor 202. A motor temperature sensor 235 (shown in FIG. 2) is positioned to provide measurements of the motor temperature (TM) to the controller 260. Additionally, in some embodiments, the return line 256 may include a flat portion or section to facilitate mounting the temperature sensor 258 (shown in FIG. 2). Accordingly, compressor temperature may include, but is not limited to, one or more of TM, TRB1, TRB2, TTHB, and/or return line temperature. In different embodiments, different temperature sensors may be placed in different locations to measure different temperatures of the system as needed.

Line 410 illustrates discharge pressure, while line 415 illustrates suction pressure. In addition, items 420 illustrate significant cooling cycles, which the present disclosure is designed to prevent. As shown in graph 400, there are large pressure swings during significant cooling cycles 420.

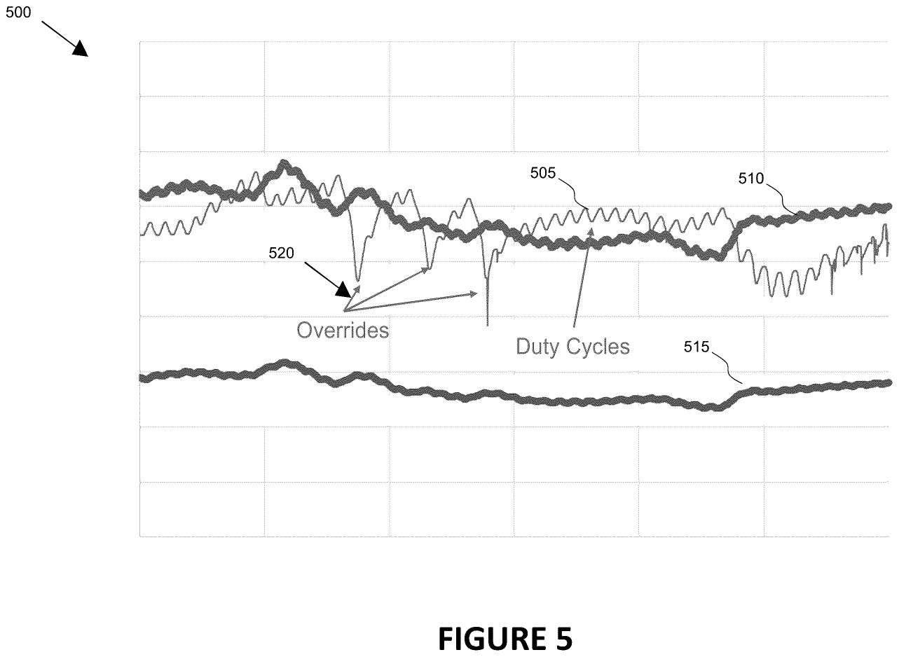

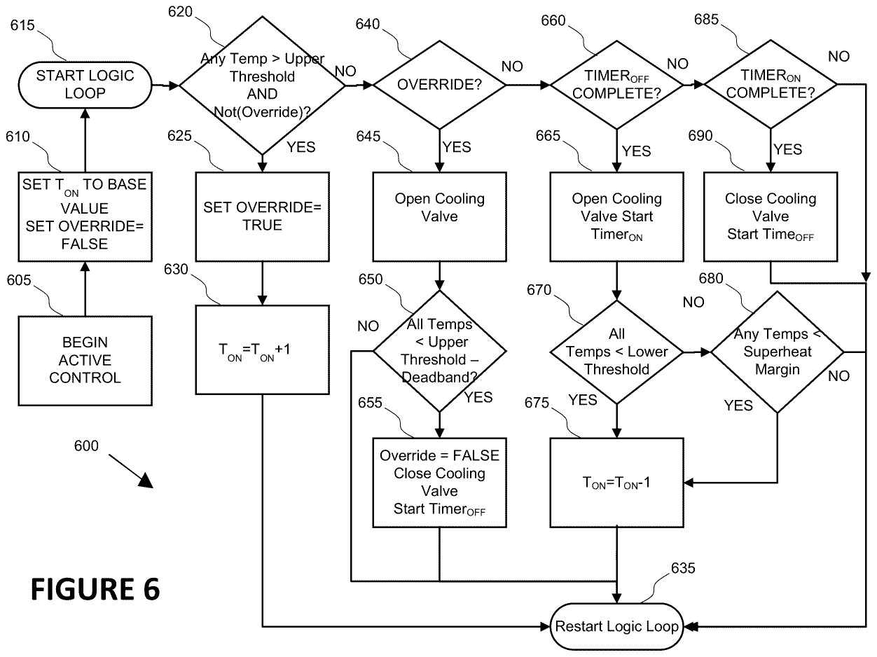

FIG. 5 is a graph 500 illustrating operation of the compressor cooling system 200 (shown in FIG. 2) using the control process 600 (described in FIG. 6). Graph 500 includes line 505 for compressor temperature, line 510 for discharge pressure, and line 515 illustrates suction pressure.

Graph 500 also shows locations where overrides 520 were activated to control cooling. The amount of time the motor coolant control valve 264 (shown in FIG. 2) is open during a given period, The Duty Cycle, is adjusted to keep all compressor temperatures within acceptable limits while minimizing the temperature swings. Each compressor temperature has an Upper and Lower threshold and a Deadband. In HVAC, the deadband is a temperature range around the set point where the thermostat doesn't activate heating or cooling. This prevents the thermostat from rapidly switching between heating and cooling, which can save energy. For example, at a 70-degree set point and a 2-degree dead band, the temperature will drop to 68 degrees before heating is activated, raising the temperature back to 70.

An override is triggered when any temperature reaches its Upper threshold, the motor coolant control valve 264 is opened until all temperatures are below their Upper thresholds minus their Deadbands. The Duty Cycle is also increased.

When the motor coolant control valve 264 turns on based on the Duty Cycle time, if all temperatures are below their Lower thresholds, the Duty Cycle is reduced. The Duty Cycle will also be reduced if any temperature is below a Superheat Margin, which is based on the suction pressure.

When the compressor starts and reaches Active Control mode, the Duty Cycle is reset to an estimated startup Duty Cycle based on compressor temperatures. In at least one embodiment, this time is set to 6 seconds.

With the new logic, the motor coolant control valve 264 will anticipate the amount of total cooling needed instead of reacting to very high or very low temperatures.

FIG. 6 illustrates a flowchart of a process 600 for controlling the operations of the compressor cooling system 200 (shown in FIG. 2). In the example embodiment, the steps of process 600 are performed by the controller 260 (shown in FIG. 2). In other embodiments, the steps of process 600 may be distributed to multiple controllers 260. Process 600 is configured to adjust the duty cycle of cooling to keep all of the compressor temperatures within acceptable limits, while minimizing the temperature swings.

Each compressor temperature is provided by one or more sensors. In an example embodiment, the first radial bearing temperature (TRB1), the second radial bearing temperature (TRB2), the motor temperature (TM), and the thrust bearing temperature (TTHB) are provided to the controller 260 (shown in FIG. 2). The bearing temperature sensors 225, 227, and 229 may be any suitable temperature sensor and may each measure the temperature of its associated bearing directly (e.g., by measuring the actual temperature of the bearing, such as by contact with the bearing) or indirectly (e.g., by measuring a temperature corresponding to or affected by the actual temperature of the bearing). The motor temperature sensor 235 (shown in FIG. 2) is positioned to provide measurements of the motor temperature (TM) to the controller 260. Additionally, in some embodiments, the return line 256 may include a flat portion or section to facilitate mounting the temperature sensor 258 (shown in FIG. 2). Accordingly, compressor temperature may include, but is not limited to, one or more of TM, TRB1, TRB2, TTHB, and/or return path temperature.

In an example embodiment, the refrigeration system 100 starts up. When the refrigeration system 100 begins 605 active control, process 600 starts up. The controller 260 sets 610 the T_{ON} value for the duty cycle to a base value. For example, for a 30 second total cycle (T_{MAX}), the controller 260 sets 610 the T_{ON} value to 6 seconds, where T_{MAX}=T_{ON}+T_{OFF}. In some embodiments, the total cycle time (T_{MAX}) can be changed based on user settings and/or the device being used. Furthermore, the initial or base T_{ON} value may be changed based on user settings, the device being used, and/or one or more attributes of the device, such as, but not limited to, pressure. Before beginning the duty cycle logic loop 615, the controller 260 also sets 610 the Override flag to FALSE.

Once the active control has begun 605, the controller 260 begins the duty cycle logic loop 615. In the duty cycle logic loop 615, the controller 260 checks 620 to see if any of the current compressor temperatures are above their upper thresholds. These upper thresholds are temperature thresholds. In some embodiments, the upper threshold values are different for different locations. In some embodiments, the controller 260 polls the different temperature sensors 225, 227, 229, 235, and 258. In other embodiments, the temperature sensors 225, 227, 229, 235, and 258 transmit their current readings on a periodic basis. If even one compressor temperature reading is above the corresponding upper threshold and the Override Flag is not TRUE, then the controller 260 sets 625 the Override flag to TRUE. The controller 260 increases 630 the T_{ON} value by one step. In some embodiments, the step is one second. In other embodiments, the step may be multiple seconds. In further embodiments, the step may be less than a second. Then the controller 260 restarts 635 the duty cycle logic loop 615. Otherwise the controller 260 continues to Step 640.

The controller 630 checks 640 if the Override flag is set to TRUE. If the Override flag is set to TRUE, the controller 630 opens 645 the cooling valve. In some embodiments, the cooling valve is the shutoff valve 274. In other embodiments, the cooling valve is the motor coolant control valve 264. In some situations, the cooling valve is already open and the controller 630 keeps the cooling valve open 645. The controller 630 checks 650 if all of the compressor temperature readings are less than their corresponding upper limits minus their deadbands. In HVAC, the deadband is a temperature range around the set point where the thermostat doesn't activate heating or cooling. This prevents the thermostat from rapidly switching between heating and cooling, which can save energy. For example, at a 70-degree set point and a 2-degree dead band, the temperature will drop to 68 degrees before heating is activated, raising the temperature back to 70. If at least one of the compressor temperatures is not less than its corresponding upper threshold minus its deadband, the controller 260 restarts 635 the duty cycle logic loop 615. If all of the compressor temperatures are less than their corresponding upper threshold minus their deadband, the controller 630 sets 655 the Override flag to FALSE, closes the cooling valve, and starts Timer_{OFF}. Then the controller 260 restarts 635 the duty cycle logic loop 615.

If the first check 620 is FALSE and the second check 640 is FALSE, the controller 260 checks 660 if the Timer_{OFF} is complete. If the Timer_{OFF} is complete, the controller 260 opens 665 the cooling valve and starts Timer_{ON}. Then the controller 260 checks 670 if all of the compressor temperatures are less than their corresponding lower thresholds. These lower thresholds are temperature thresholds. In some embodiments, the lower threshold values are different for different locations. If all of the compressor temperatures are less than their corresponding lower thresholds, the controller 260 reduces 675 the T_{ON} value by one step. In some embodiments, the step is one second. In other embodiments, the step may be multiple seconds. In further embodiments, the step may be less than a second. Then the controller 260 restarts 635 the duty cycle logic loop 615. If all of the compressor temperatures are not less than their corresponding lower thresholds, the controller 260 checks 680 if any of the controller temperatures are less than a superheat margin. A superheat margin (or threshold) is calculated using a saturation temperature based upon suction pressure and an added margin, such as 30°. The superheat margin may be further based upon the compressor condition. If any compressor temperature is less than the superheat margin, the controller proceeds to Step 675 as described above. If no compressor temperature is less than the superheat margin, the controller 260 restarts 635 the duty cycle logic loop 615.

If the first check 620, the second check 640, and the third check 660 are all FALSE, the controller 260 checks 685 if the Timer_{ON} is complete. If the Timer_{ON} is complete, the controller 260 closes 690 the cooling valve and starts Timer_{OFF}. Then the controller 260 restarts 635 the duty cycle logic loop 615. If the Timer_{ON} is not complete, the controller 260 restarts 635 the duty cycle logic loop 615.

In an example embodiment, the duty cycle logic loop 615 continues while the compressor is in active control mode.

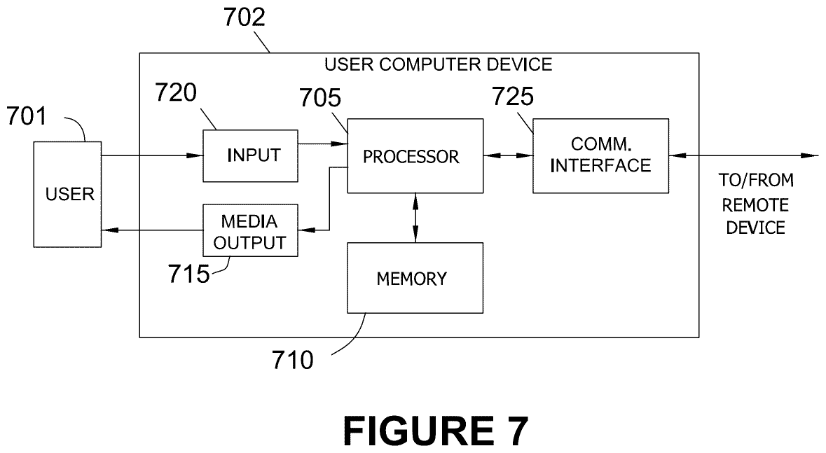

FIG. 7 depicts an example configuration of client computer devices, in accordance with one embodiment of the present disclosure. User computer device 702 may be operated by a user 701. User computer device 702 may include, but is not limited to, controller 260 (shown in FIG. 2).

User computer device 702 may include a processor 705 for executing instructions. In some embodiments, executable instructions are stored in a memory area 710. Processor 705 may include one or more processing units (e.g., in a multi-core configuration). Memory area 710 may be any device allowing information such as executable instructions and/or transaction data to be stored and retrieved. Memory area 710 may include one or more computer readable media.

User computer device 702 may also include at least one media output component 715 for presenting information to user 701. Media output component 715 may be any component capable of conveying information to user 701. In some embodiments, media output component 715 may include an output adapter (not shown) such as a video adapter and/or an audio adapter. An output adapter may be operatively coupled to processor 705 and operatively coupled to an output device such as a display device (e.g., a cathode ray tube (CRT), liquid crystal display (LCD), light emitting diode (LED) display, or “electronic ink” display) or an audio output device (e.g., a

### Speaker or Headphones).

In some embodiments, media output component 715 may be configured to present a graphical user interface (e.g., a web browser and/or a client application) to user 701. A graphical user interface may include, for example, temperature information. In some embodiments, user computer device 702 may include an input device 720 for receiving input from user 701. User 701 may use input device 720 to, without limitation, input temperature information.

Input device 720 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 715 and input device 720.

User computer device 702 may also include a communication interface 725, communicatively coupled to a remote device such as a client computing device (not shown). Communication interface 725 may include, for example, a wired or wireless network adapter and/or a wireless data transceiver for use with a wireless network.

Stored in memory area 710 are, for example, computer readable instructions for providing a user interface to user 701 via media output component 715 and, optionally, receiving and processing input from input device 720. A user interface may include, among other possibilities, a web browser and/or a client application. Web browsers enable users, such as user 701, to display and interact with media and other information typically embedded on a web page or a website from controller 260. A client application allows user 701 to interact with. For example, instructions may be stored by a cloud service, and the output of the execution of the instructions sent to the media output component 715.

Processor 705 executes computer-executable instructions for implementing aspects of the disclosure. In some embodiments, the processor 705 is transformed into a special purpose microprocessor by executing computer-executable instructions or by otherwise being programmed. For example, the processor 705 may be programmed with the instructions such as process 600 (shown in FIG. 6, respectively).

### Additional Considerations

Example embodiments of compressor systems and methods, such as refrigerant compressors, are described above in detail. The systems and methods are not limited to the specific embodiments described herein, but rather, components of the system and methods may be used independently and separately from other components described herein. For example, the cooling circuits described herein may be used in compressors other than centrifugal compressors, including, for example and without limitation, scroll compressors, rotary compressors, and reciprocating compressors.

Example embodiments of compressor systems and methods, such as refrigerant compressors, are described above in detail. The systems and methods are not limited to the specific embodiments described herein, but rather, components of the system and methods may be used independently and separately from other components described herein. For example, the cooling circuits described herein may be used in compressors other than centrifugal compressors, including, for example and without limitation, scroll compressors, rotary compressors, and reciprocating compressors.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A compressor system comprising:
a compressor comprising:
a compressor housing defining one or more refrigerant inlets;
a cooling circuit comprising:
one or more coolant supply lines connected to the compressor housing to deliver coolant to the one or more refrigerant inlets; and
a cooling valve configured to control a flow of coolant via the one or more coolant supply lines;
one or more temperature sensors to measure temperature at one or more locations in the compressor; and
a controller comprising a processor and a memory, the controller connected to the one or more temperature sensors and the cooling valve, the memory storing instructions that when executed by the processor configures the controller to:
control the compressor to compress refrigerant delivered to the one or more refrigerant inlets;
store a time T_{ON}, a time T_{OFF}, and an override flag; and
execute a duty cycle logic loop comprising:
receive compressor temperature readings from the one or more temperature sensors for the one or more locations;
if a determination is that any of the compressor temperature readings are above an upper temperature threshold, increment the time T_{ON}, set the override flag to true, and open the cooling valve;
if a determination is that the override flag is set to true and all of the compressor temperature readings are below the upper temperature threshold, close the cooling valve, set the override flag to false, and begin time T_{OFF}; and
if a determination is that all compressor temperature readings are lower than a lower temperature threshold, decrement time T_{ON}.

2. The compressor system of claim 1, wherein the duty cycle logic loop further comprises if a determination is that time T_{OFF} is complete, open the cooling valve, start time T_{ON}, and determine if all compressor temperature readings are lower than the lower temperature threshold.

3. The compressor system of claim 1, wherein the duty cycle logic loop further comprises if a determination is that time T_{ON} is complete, close the cooling valve and begin time T_{OFF}.

4. The compressor system of claim 1, wherein the compressor temperature readings include one or more of a first radial bearing temperature, a second radial bearing temperature, a thrust bearing temperature, a motor temperature, and a return line temperature.

5. The compressor system of claim 1, wherein the duty cycle logic loop begins when the compressor enters an active control mode.

6. The compressor system of claim 1, wherein the duty cycle logic loop further comprises decrement time T_{ON} when any compressor temperature reading is below a superheat margin.

7. The compressor system of claim 1, if a determination is that the override flag is true and that all of the compressor temperature readings are below the upper temperature threshold minus a deadband, close the cooling valve, set the override flag to false, and begin time T_{OFF}.

8. The compressor system of claim 1, wherein the upper temperature threshold includes an upper temperature threshold for each of the locations.

9. The compressor system of claim 8, wherein the upper temperature thresholds for two different locations are different.

10. The compressor system of claim 1, wherein the lower temperature threshold includes a lower temperature threshold for each of the locations.

11. A controller comprising at least one processor and at least one memory, the controller connected to one or more temperature sensors to measure one or more locations on a device and a cooling valve for controlling a flow of coolant to the one or more locations on the device, the at least one memory storing instructions that when executed by the at least one processor configures the controller to:
store a time T_{ON}, a time T_{OFF}, and an override flag; and
execute a duty cycle logic loop comprising:
receive temperature readings from the one or more temperature sensors for the one or more locations;
if a determination is that any of the temperature readings are above an upper temperature threshold, increment the time T_{ON}, set the override flag to true, and open the cooling valve;
if a determination is that the override flag is set to true and all of the temperature readings are below the upper temperature threshold, close the cooling valve, set the override flag to false, and begin time T_{OFF}; and
if the determination is that all temperature readings are lower than a lower temperature threshold, decrement time T_{ON}.

12. The controller of claim 11, wherein the duty cycle logic loop further comprises if a determination is that time T_{OFF} is complete, open the cooling valve, start time T_{ON}, and determine if all temperatures readings are lower than the lower temperature threshold.

13. The controller of claim 11, wherein the duty cycle logic loop further comprises if a determination is that time T_{ON} is complete, close the cooling valve and begin time T_{OFF}.

14. The controller of claim 11, wherein the temperature readings include one or more of a first radial bearing temperature, a second radial bearing temperature, a thrust bearing temperature, a motor temperature, and a return line temperature.

15. The controller of claim 11, wherein the duty cycle logic loop begins when the device enters an active control mode.

16. The controller of claim 11, wherein the duty cycle logic loop further comprises decrement time T_{ON} when any temperature reading is below a superheat margin.

17. The controller of claim 11, if a determination is that the override flag is true and that all of the compressor temperature readings are below the upper temperature threshold minus a deadband, close the cooling valve, set the override flag to false, and begin time T_{OFF}.

18. A method for controlling a compressor implemented by a controller comprising at least one processor and at least one memory, the controller in communication with one or more temperature sensors to measure one or more locations on the compressor and a cooling valve for controlling a flow of coolant to the one or more locations on the compressor, the method comprises:
storing a time T_{ON}, a time T_{OFF}, and an override flag; and
executing a duty cycle logic loop comprising:
receiving temperature readings from the one or more temperature sensors for the one or more locations;
if a determination is that any of the temperature readings are above an upper temperature threshold, incrementing the time T_{ON}, setting the override flag to true, and opening the cooling valve;
if a determination is that the override flag is set to true and all of the temperature readings are below the upper temperature threshold, closing the cooling valve, setting the override flag to false, and beginning time T_{OFF}; and
if the determination is that all temperature readings are lower than a lower temperature threshold, decrementing time T_{ON}.

19. The method of claim 18, wherein the temperature readings include one or more of a first radial bearing temperature, a second radial bearing temperature, a thrust bearing temperature, a motor temperature, and a return line temperature.

20. The method of claim 18, wherein the duty cycle logic loop further comprises decrementing time T_{ON} when any temperature reading is below a superheat margin.
